(19) United States
(12) Patent Application Publication
(10) Pub. No.: US 2022/0061223 A1
(43) Pub. Date: Mar. 3, 2022

(54) VENTED FLOORS AND ASSOCIATED SYSTEMS AND METHODS FOR MANUFACTURE AND USE

(71) Applicant: Storage Systems Northwest, Inc., Kennewick, WA (US)

(72) Inventors: Joel Micka, Kennewick, WA (US); Jonathan Robert Prince, Richland, WA (US)

(21) Appl. No.: 17/463,015

(22) Filed: Aug. 31, 2021

Related U.S. Application Data
(60) Provisional application No. 63/073,820, filed on Sep. 2, 2020.

(51) Int. Cl. A01F 25/22; E04B 5/48; F24F 7/06

(52) U.S. Cl. CPC A01F 25/22; F24F 7/06; E04B 5/48

(57) ABSTRACT

Vented floor structures are described herein. In some embodiments, precast vented floor structures (which can also be referred to as “air floors”) can be used in crop storage facilities, such as potato, onion, and/or other crop storage facilities. Embodiments of the vented floor structures described herein can be manufactured using a form to create air vents in the floor structure that do not require plastic shells or other ancillary structures to define or create the vent openings. Embodiments also include inserts that can be installed (e.g., removably installed) in vent openings to vary the opening size and/or configuration, or complete plug selected vent openings.

### CROSS-REFERENCE TO RELATED APPLICATION

The present application claims priority to U.S. Provisional Patent Application No. 63/073,820, filed Sep. 2, 2020, and incorporated by reference herein in its entirety.

### TECHNICAL FIELD

The present disclosure is generally related to vented floor structures for use in crop storage facilities, and associated systems and methods for manufacture and use.

### BACKGROUND

Potatoes, onions, and other crops and produce are typically held in large storage facilities after harvest to maintain quality and provide a uniform supply of product to market. Potato storage facilities, for example, can hold more than 20,000 tons of potatoes in piles as high as 20 feet. These piles can generate considerable heat from respiration of the potatoes. For this reason, conventional storage facilities typically include ventilation systems. They can also include systems for controlling the air temperature and humidity to prevent excessive dehydration, decay, and the development of high sugar concentrations in the potatoes. Conventional crop storage facilities may also include systems for circulating treatment agents (e.g., chlorine dioxide gas) through the stored crops to prevent or reduce spoilage and rot.

Conventional potato storage facilities typically include a series of vents or other openings on an exterior wall for introducing outside air into the facility. This air can be cooled and/or conditioned to increase the moisture content by moving the air through an air cooler (e.g., an evaporative cooler), a humidifier, and/or other known air conditioning devices. Additionally, crop treatment agent may be mixed with the air before it is directed through a series of ventilation ducts or pipes that extend underneath the pile of potatoes. The ducts are typically perforated along their lengths to allow the cool, moist air to flow out of the ducts and upwardly through the potatoes, cooling the potatoes and preventing excessive dehydration, spoilage, and/or rot, etc. After flowing through the pile of potatoes, the warm air is typically exhausted through one or more vents in an exterior wall of the facility. Storage facilities and related systems and methods are disclosed in U.S. Pat. No. 8,991,123, titled ENVIRONMENTALLY CONTROLLED STORAGE FACILITY FOR POTATOES AND OTHER CROPS and filed on Apr. 15, 2013, and U.S. Pat. No. 10,076,129, titled SYSTEMS AND METHODS FOR INHIBITING SPOILAGE OF STORED CROPS and filed on May 12, 2017, both of which are incorporated herein by reference in their entireties. U.S. Pat. No. 5,713,172, titled STORAGE FLOOR AIR VENT AND METHOD OF ITS USE and filed on Nov. 3, 1995, is also incorporated herein by reference in its entirety. Some floor structures have plastic shells cast into a concrete slab to form air vents. However, in use the vents may become clogged from failure or collapse of the plastic shells and/or trapped debris.

### BRIEF DESCRIPTION OF THE DRAWINGS

FIG. 1 is a top isometric view of a vented floor structure configured in accordance with embodiments of the present technology.

FIG. 2A is a top view of the vented floor structure of FIG. 1, FIG. 2B is an enlarged top view of a portion of the vented floor structure showing a vent opening configured in accordance with embodiments of the present technology, FIG. 2C is a cross-sectional end view of the vented floor structure taken substantially along line 2C-2C in FIG. 2A, and FIG. 2D is a cross-sectional side view of a vent opening taken substantially along line 2D-2D in FIG. 2A.

FIG. 3A is a top view of a vented floor structure configured in accordance with other embodiments of the present technology, FIG. 3B is an enlarged top view of a portion of the vented floor structure of FIG. 3A showing a vent opening, FIG. 3C is a cross-sectional end view of the vented floor structure taken substantially along line 3C-3C in FIG. 3A, and FIG. 3D is a cross-sectional side view of a vent opening taken substantially along line 3D-3D in FIG. 3A.

FIG. 4 is a top isometric view of a vent insert configured in accordance with embodiments of the present technology.

FIG. 5A is a top view of a portion of the vented floor structure of FIG. 3A with a plurality of the vent inserts of FIG. 4 removably installed in corresponding vent openings in accordance with embodiments of the present technology, FIG. 5B is a cross-sectional side view of an installed vent insert taken substantially along line 5B-5B in FIG. 5A, FIG. 5C is a cross-sectional front view of the installed vent insert taken substantially along line 5C-5C in FIG. 5A, and FIG. 5D is a cross-sectional front view of an installed vent insert configured in accordance with other embodiments of the present technology.

FIGS. 6A-6E are top isometric views of vent inserts configured accordance with various embodiments of the present technology.

FIGS. 7A and 7B are top and cross-sectional end views, respectively, of the vented floor structures of FIGS. 1 and 3A illustrating an arrangement of rebar reinforcement configured in accordance with embodiments of the present technology.

FIG. 8A is a perspective end view of a precast concrete form configured in accordance with embodiments of the present technology for forming the vented floor structure of FIG. 1, and FIG. 8B is an end view illustrating a use of the form to cast the vented floor structure in accordance with embodiments of the present technology.

FIGS. 9A-9C are a series of side, front end, and top cross-sectional views, respectively, of an example crop storage facility in which the vented floor structures of FIGS. 1-6E can be used, in accordance with embodiments of the present technology.

### DETAILED DESCRIPTION

The following disclosure describes various embodiments of vented floor structures that can be used in crop storage facilities to provide air and/or air mixed with crop treatment agents to crops stored on the floor structures. Such floor structures are sometimes referred to as “air floors” and the like, and can be used in facilities for storing potatoes, onions, apples, carrots, hemp, and/or other crops, produce, etc. As described in greater detail below, in some embodiments, the vented floor structures disclosed herein are precast concrete structures that include a concrete slab supported by two or more vertical walls which form air plenums extending underneath the slab. Additionally, the slab can include a plurality of vent openings (which can also be referred to as “passages,” “holes,” “ducts,” or simply “vents,” etc.) that are formed during casting to enable air, and/or air mixed with crop treatment agent, to flow upwardly through the vents and into a pile of potatoes, onions, or other crops stored on the floor structure. In one aspect of the present technology, the vent openings can be formed during the casting process and without the use of plastic shells or other structures that are permanently cast into the concrete to form the vents. As a result, the vents are less susceptible to clogging due to failure of the cast-in vent-forming structures and/or the accumulation of debris inside the vent-forming structures. Additionally, in some embodiments the vent structures described herein can include vent inserts that can be removably installed in the vent openings to, e.g., control the flow of air through the vent openings, reduce or prevent clogging of the vent openings, etc. The vent inserts can have various configurations to serve multiple purposes and/or to customize the vent arrangement to suit a particular crop, storage system, etc. For example, as described in detail below, the vent inserts can have different vent opening sizes, orientations and/or covers (e.g., a grate, a mesh screen, etc.) to accommodate different types/sizes of the various crops and/or crop storage equipment (e.g., bins) stored on the floor structure. Additionally, in some embodiments the inserts can be used to completely plug some of the vent openings to direct and increase the air flow through other vent openings (e.g., openings positioned under a pile of crops and/or a crop storage bin).

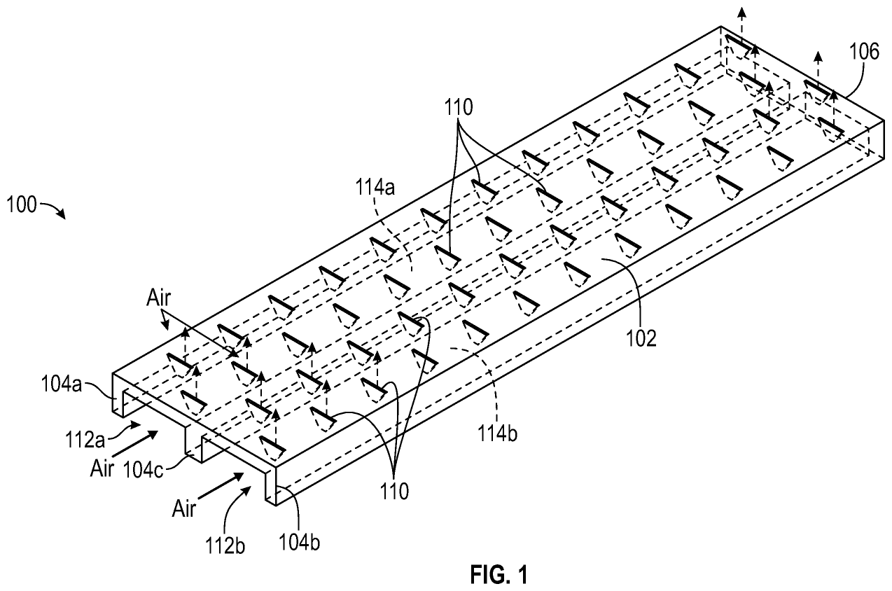

Certain details are set forth in the following description and in FIGS. 1-9C to provide a thorough understanding of various embodiments of the present technology. In other instances, well-known structures, materials, operations and/or systems often associated with precast concrete structures, crop storage facilities, etc. are not shown or described in detail in the following disclosure to avoid unnecessarily obscuring the description of the various embodiments of the technology. Those of ordinary skill in the art will recognize, however, that the present technology can be practiced without one or more of the details set forth herein, or with other structures, methods, components, and so forth.

The terminology used below is to be interpreted in its broadest reasonable manner, even though it is being used in conjunction with a detailed description of certain examples of embodiments of the technology. Indeed, certain terms may even be emphasized below; however, any terminology intended to be interpreted in any restricted manner will be overtly and specifically defined as such in this Detailed Description section.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as position of components and certain precise connections between such components when such details are unnecessary for a complete understanding of how to make and use the invention.

Many of the details, dimensions, angles and other features shown in the Figures are merely illustrative of particular embodiments of the present technology. Accordingly, other embodiments can have other details, dimensions, angles and features without departing from the spirit or scope of the present disclosure. In addition, those of ordinary skill in the art will appreciate that further embodiments of the present technology can be practiced without several of the details described below.

As used herein, the use of relative terminology, such as “about”, “approximately”, “substantially” and the like refer to the stated value plus or minus ten percent. For example, the use of the term “about 100” refers to a range of from 90 to 110, inclusive. In instances in which relative terminology is used in reference to something that does not include a numerical value, the terms are given their ordinary meaning to one skilled in the art.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1 is a top isometric view of a vented floor structure 100 configured in accordance with embodiments of the present technology. In the illustrated embodiment, the vented floor structure 100 (which can also be referred to as an “air floor” and the like) is a precast concrete structure having a horizontal slab 102 supported by a plurality of longitudinal walls 104. More specifically, the vented floor structure 100 includes a first longitudinal side wall 104a on one side of the slab 102 and a second longitudinal side wall 104b on the opposite side of the slab 102. Additionally, in some embodiments, the vented floor structure 100 further includes a central longitudinal wall 104c positioned at or near the middle of the slab 102. The longitudinal walls 104a-c elevate the slab 102 above the surface upon which the floor structure 100 is placed (e.g., the floor of a crop storage building), and thereby define two longitudinal plenums 114a and 114b which extend under the slab 102 and have corresponding inlets 112a and 112b. An end wall 106 extends across the longitudinal side walls 104a-c at the aft end of the vented floor structure 100 to effectively cap off the longitudinal plenums 114a, b. It will be appreciated that the cross-sectional size of the plenums 114a, b and the corresponding inlets 112a, b can be increased or decreased as desired by increasing or decreasing, respectively, the heights of the walls 104a-c and/or the widths of the inlets 112a, b, accordingly.

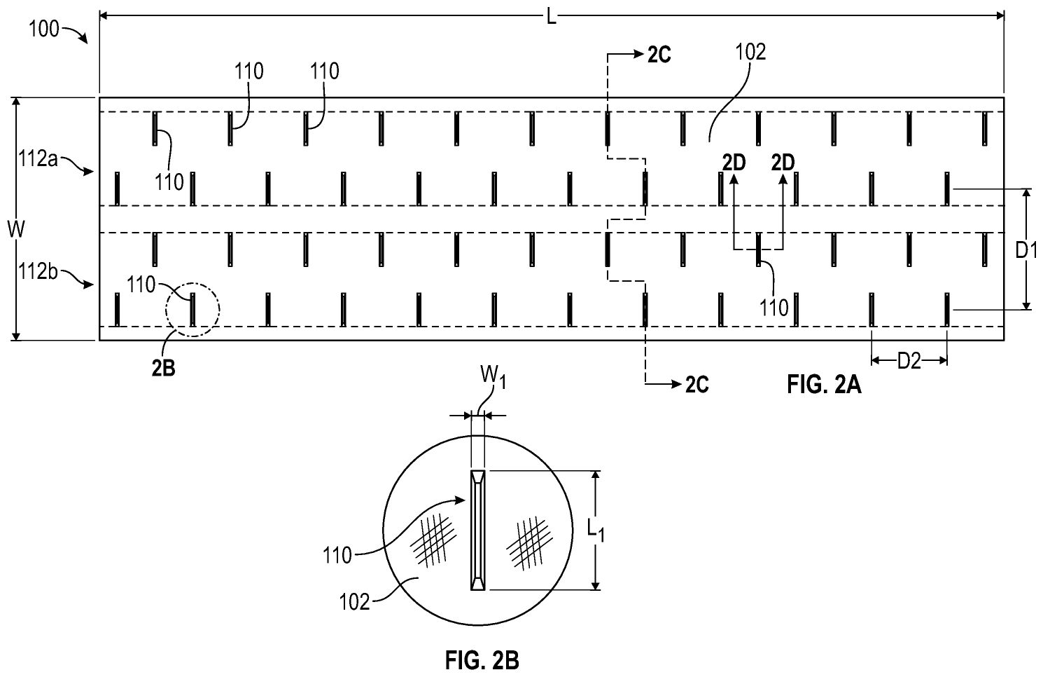

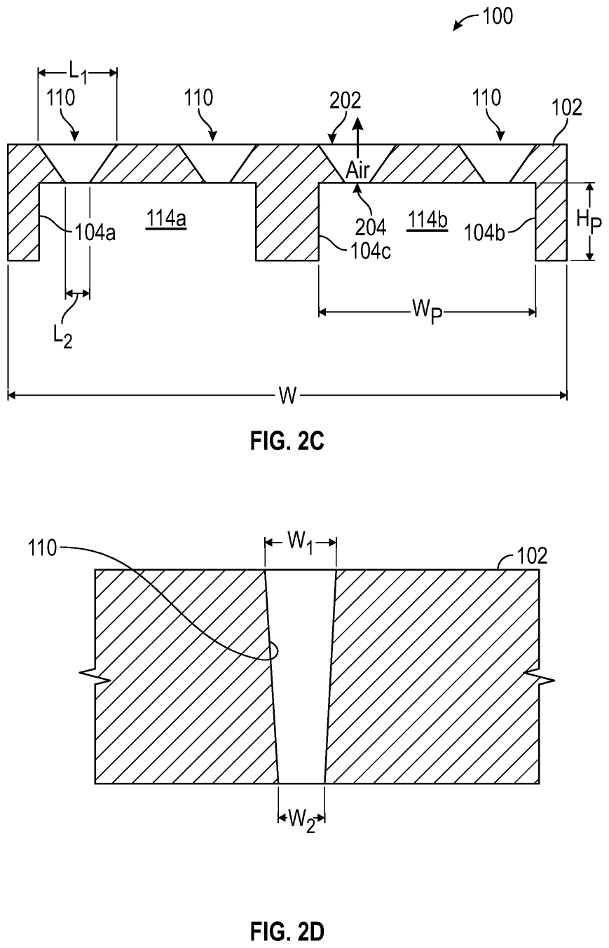

The vented floor structure 100 further includes a plurality of vent openings 110 (which can also be referred to as “vent holes,” “vent passages,” “vent ducts,” etc.) extending through the slab 102 above the plenums 114a and 114b. More specifically, in some embodiments, the vented floor structure 100 includes two longitudinal rows of staggered vent openings 110 positioned directly above the respective plenums 114a and 114b (for a total of 4 longitudinal rows of vent openings 110). The vent openings 110 (which can also be referred to as “vents 110” for ease of reference) are described in greater detail below with reference to FIGS. 2A-2C. In operation, air (and/or air mixed with crop treatment agent or other substance) flows into the plenums 114a, b via the corresponding inlets 112a, b and then flows upwardly through the slab 102 via the vent openings 110 (for ease of reference, the use of the term “air” herein refers to both air and air mixed with crop treatment agents and/or other substances). From there, the air/air mixture can flow upwardly through the crops (e.g., potatoes, onions, carrots, hemp, etc.) piled on the floor structure 100 to, e.g., control the temperature and/or humidity of the crops, prevent spoilage, etc.

FIG. 2A is a top view of the vented floor structure 100 configured in accordance with embodiments of the present technology, and FIG. 2B is an enlarged view of a portion of the vented floor structure taken from FIG. 2A and illustrating certain features of the vent openings 110 in more detail. As shown in FIG. 2A, in some embodiments the vented floor structure 100 can have a length L of from about 18 feet to about 26 feet (e.g., about 22 feet 5 inches), and a width W of from about 4 feet to about 8 feet (e.g., about 6 feet). Additionally, the vent openings 110 can be individually oriented so that they extend transversely across the slab 102 and can be arranged in four staggered rows extending longitudinally along the length of the slab 102. In some embodiments, the vent openings 110 can be spaced apart by a distance D₁ of from about 1 ft to about 4 ft (e.g., about 3 ft) in each lateral row, and spaced apart by a distance D₂ of from about 1 ft to about 3 ft (e.g., about 2 ft) in each longitudinal row. As shown in FIG. 2B, in some embodiments, the vent openings 110 can have a length L₁ at the top surface of the slab 102 of from about 8 inches to about 16 inches (e.g., about 10 inches), and a corresponding width W₁ of from about 0.5 inch to about 2.5 inches (e.g., about 1.25 inches). The foregoing dimensions of the vented floor structure 100, the vent openings 110, the positions, spacing, and/or arrangements of the vent openings and/or other features described above are provided by way of examples of some embodiments. One skilled in the art will recognize that the present disclosure encompasses vented floor structures having dimensions outside the foregoing ranges. For example, in other embodiments the vent openings 110 can be spaced apart by other distances (e.g., distances of less than 1 ft or greater than 4 ft) in each lateral row and/or longitudinal row, or the spacings can be different in different rows. Accordingly, the present technology is not limited to the foregoing dimensions, sizes, positions, orientations, spacings, etc., and other embodiments may have other dimensions, positions, orientations and spacings without departing from the present disclosure.

FIG. 2C is a cross-sectional end view of the vented floor structure 100 taken along line 2C-2C in FIG. 2A, and FIG. 2D is a cross-sectional side view of one of the vent openings 110 taken along line 2D-2D in FIG. 2A, illustrating further details in accordance with embodiments of the present technology. Referring first to FIG. 2C, in some embodiments, the individual plenums 114a, b each have a height H_{P} of from about 5 inches to about 24 inches (e.g., about 10 inches), and a width W_{P} of from about 1 ft to about 4 ft (e.g., about 2 ft 4 inches). As noted above, however, the height and/or width of the plenums 114a, b can be varied to suit a particular application or facility by simply changing the height or the lateral spacing of the walls 104a-c, respectively.

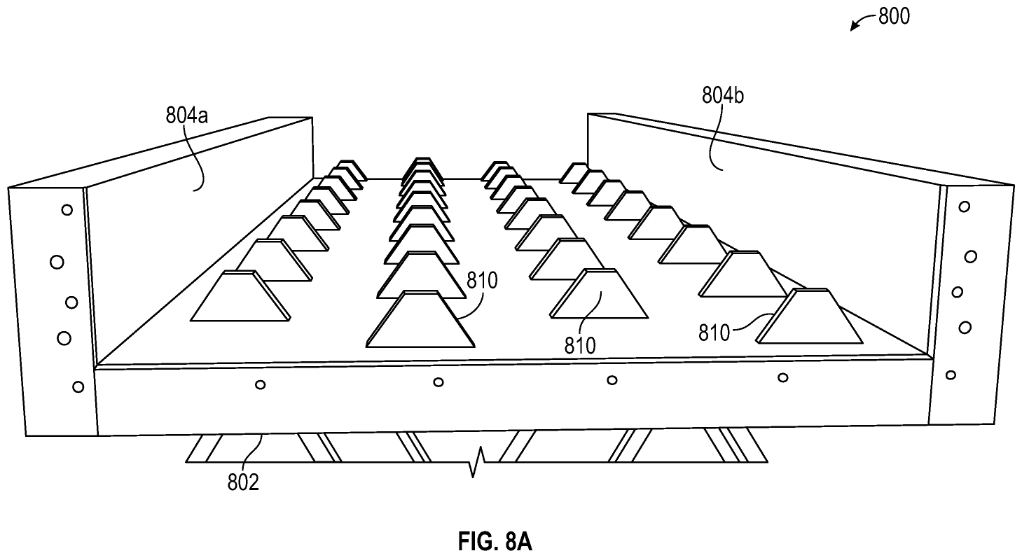

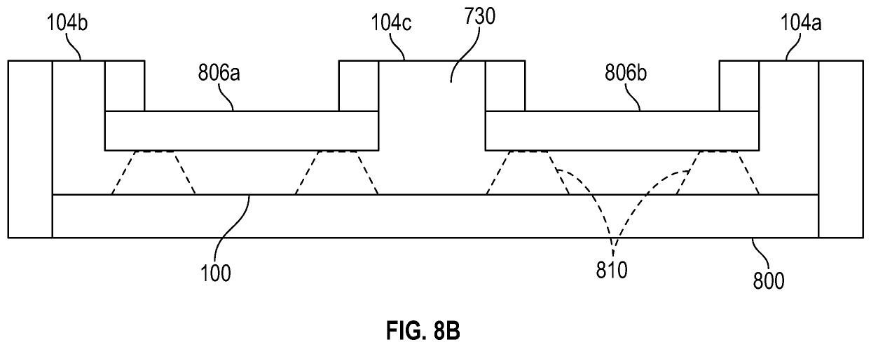

In some embodiments, the individual vent openings 110 can have the shape of an isosceles trapezoid that forms a first opening 202 (e.g., an outlet opening) at the top surface of the slab 102 that has the length L₁ of from about 6 inches to about 16 inches (e.g., about 10 inches) as described above with reference to FIG. 2B, and a second opening 204 (e.g., an inlet opening) at the bottom surface of the slab 102 that has a length L₂ of from about 2 inches to about 5 inches (e.g., about 3.1 inches). As shown in FIG. 2D, the vent opening 110 can have the width W₁ at the top surface of the slab 102 of from about 0.5 inches to about 2.5 inches (e.g., about 1.25 inches), and a corresponding width W₂ at the bottom surface of the slab 102 of from about 0.5 inch to about 2 inches (e.g., about 1 inch). As described in greater detail below with reference to FIGS. 8A-8B, forming all four sides of the vent openings 110 so that they taper inwardly toward the bottom of the slab 102 as shown in FIGS. 2C and 2D can facilitate removal of the cast floor structure 100 from the corresponding mold or form after the casting process.

In other embodiments, it will be appreciated that various other vent opening sizes, shapes, quantities, positions and/or orientations can be used with vented floor structures configured in accordance with the present technology. By way of example only, such vent openings can include rectangular vent openings, curved vent openings, tapered and non-tapered vent openings, non-isosceles trapezoid openings, isosceles trapezoid-shaped openings that are inverted with respect to their position as shown in FIG. 2C, etc. Accordingly, the present disclosure is not limited to any particular vent opening shape, size, orientation, quantity, and/or position.

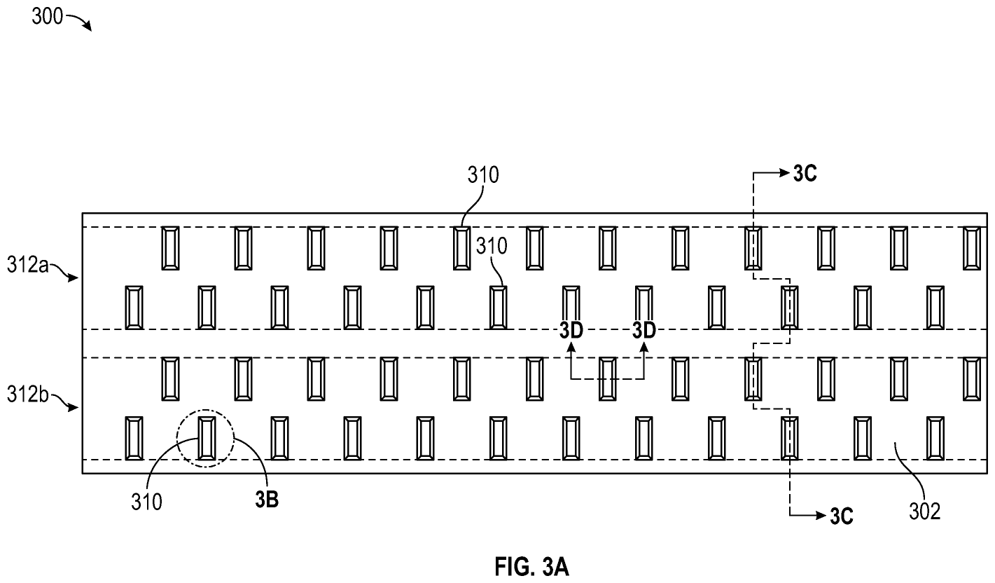

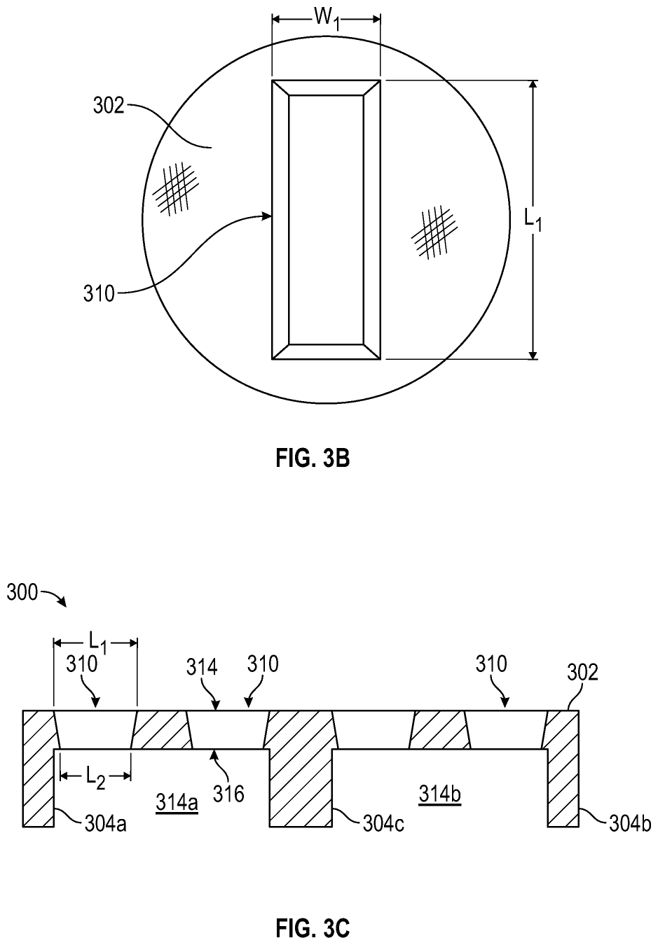

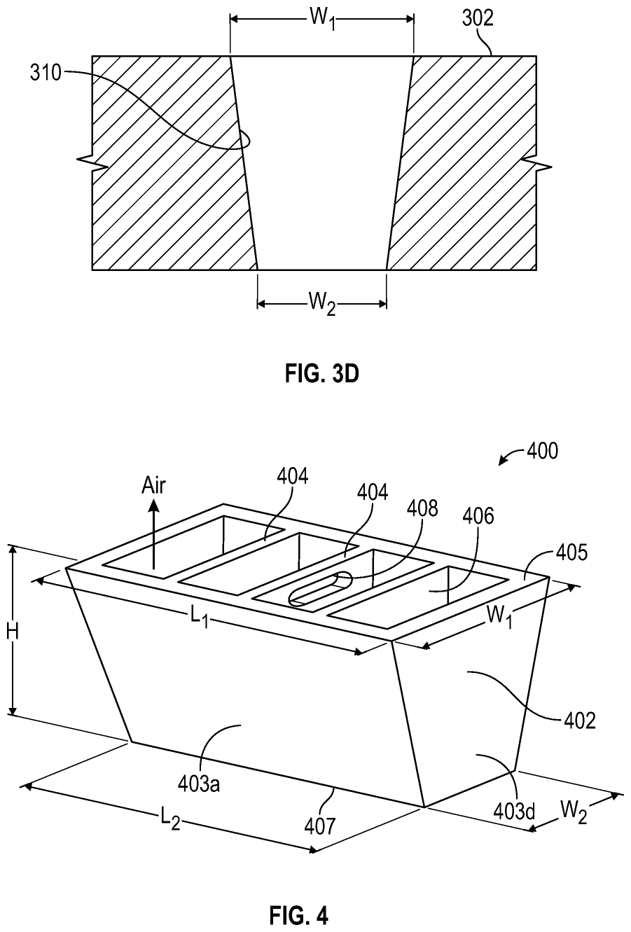

FIG. 3A is a top view of a vented floor structure 300 configured in accordance with other embodiments of the present technology, and FIG. 3B is an enlarged view of a portion of the vented floor structure 300 taken from FIG. 3A and illustrating certain features of a vent opening 310 (which can also be referred to as a “vent hole,” “vent passage,” “vent duct,” or simply a “vent” or “opening”) in more detail. Many aspects of the vented floor structure 300 can be at least generally similar in structure and function to the vented floor structure 100 described in detail above with reference to FIGS. 1-2C. For example, the vented floor structure 300 can be a precast concrete structure having longitudinal plenums fed by corresponding inlets 312a and 312b. In one aspect of this embodiment, however, the vented floor structure 300 includes a plurality of vent openings 310 that are generally larger than the vent openings 110 described above. For example, as shown in FIG. 3B, in some embodiments the vent opening 310 has a length L₁ at the top surface of the slab 302 of from about 8 inches to about 24 inches (e.g., about 12 inches), and a corresponding width W₁ of from about 2 inches to about 8 inches (e.g., about 4 inches).

FIG. 3C is a cross-sectional end view of the vented floor structure 300 taken substantially along line 3C-3C in FIG. 3A, and FIG. 3D is a cross-sectional side view of a vent opening 310 taken along line 3D-3D in FIG. 3A. As shown in FIG. 3C, in some embodiments the individual vent openings 310 can have the shape of an isosceles trapezoid that forms a first opening 314 (e.g., an outlet opening) at the top surface of the slab 302 that has the length L₁ of from 8 inches to about 24 inches (e.g., about 12 inches) as described above with reference to FIG. 3B, and a second opening 316 (e.g., an inlet opening) at the bottom surface of the slab 302 that has a length L₂ slightly less than the length L₁, such as from about 6 inches to about 22 inches (e.g., about 11.5 inches). As shown in FIG. 3D, the vent opening 310 can have the width W₁ at the top surface of the slab 302 of from about 2 inches to about 8 inches (e.g., about 4 inches) as described above with reference to FIG. 3B, and a corresponding width W₂ at the bottom surface of the slab 302 of from about 1.5 inches to about 7.5 inches (e.g., about 3.5 inches). As discussed above, forming all four sides of the vent opening 310 so that they taper inwardly toward the bottom of the slab 302 as shown in FIGS. 3C-3D can facilitate removal of the cast floor structure 100 from the corresponding form after the casting process. This shape can also facilitate installation and removal of vent inserts from the vent openings, as described in detail below. It will be appreciated that the dimensions, sizes, shapes, positions, and/or orientations, etc. of the vent openings 310 described above are provided by way of example of some embodiments, and other embodiments can have other dimensions, shapes, sizes, etc. without departing from the present disclosure.

It will be noted that the vent openings 310 are somewhat larger, in general, than the vent openings 110 described in detail above with reference to FIGS. 1-2D. In one aspect of this embodiment, the vent openings 310 are configured to receive removable inserts that can be used to, e.g., vary the size of the vent opening, control the airflow through the vent opening, provide a protective cover or screen over the vent opening, plug selected vent openings, etc. For example, FIG. 4 is a top isometric view of a vent insert 400 configured in accordance with embodiments of the present technology. The vent insert 400 is configured to be removably received in one of the openings 310 described above. In some embodiments, the insert 400 includes a body 402 having four outer wall portions 403a-d and a plurality of partitions or inner wall portions 404 that form a plurality of (e.g., four) air passages 406. The inner wall portions 404 separate the overall opening of the vent insert 400 into four smaller openings and serve as a “grate” that reduces the likelihood of objects falling into the vent opening and/or clogging the opening. In addition to the foregoing features, the vent insert 400 can additionally include a gripping or handle feature, such as an opening 408 in one of the inner wall portions 404 that provides a handle for a user to manually grasp the insert 400 and position it in a corresponding opening 310 or remove it from a corresponding opening 310.

As noted above, the insert 400 is configured to be removably installed in a corresponding one of the openings 310. In this regard, the insert 400 can be shaped and sized so that it fits easily into the opening 310 and is firmly supported in the opening 310, and can also be manually removed from the opening 310. By way of example, if the vent opening 310 has a length on the top surface of the slab 302 of about 12 inches (e.g., the length L₁ shown in FIGS. 3B and 3C), a length on the lower surface of the slab 302 of about 11.5 inches (e.g., the length L₂ shown in FIG. 3C), a width on the top surface of the slab 302 of about 4 inches (e.g., the width W₁ shown in FIGS. 3B and 3D), and a width on the lower surface of the slab 302 of about 3.5 inches (e.g., the width W₂ shown in FIG. 3D), then the insert 400 can have a length L₁ of, e.g., about 11.97 inches at an upper surface 405 and a corresponding length L₂ of, e.g., about 11.45 inches at a lower surface 407; a width W₁ of, e.g., about 3.97 inches at the upper surface 405 and a corresponding width W₂ of, e.g., about 3.45 inches at the lower surface 407; and a height H of, e.g., about 4.9 inches between the upper surface 405 and the lower surface 407. It will be appreciated that these dimensions are provided by way of example only and to demonstrate that the dimensions of the insert 400, in some embodiments, can be almost the same as, but slightly less than, the dimensions of the corresponding opening 310. Accordingly, in other embodiments the vent insert 400 can have other dimensions when used with the vent opening 310, and other vent opening sizes will likely necessitate other vent insert sizes. Therefore, the present technology is not limited to the particular dimensions provided in FIG. 4.

The vent insert 400 can be manufactured using various suitable materials and various suitable methods known in the art. For example, in some embodiments the insert 400 can be manufactured from stainless steel (e.g., stainless steel plate) that is welded, machined, cast, fastened, or otherwise formed to shape. In other embodiments, the insert 400 can be formed from other materials, such as other metals (e.g., aluminum (such as cast aluminum), mild steel, etc.), high strength plastics (e.g., ultra-high-molecular-weight polyethylene (UHMWPE)) and other polymer materials, composite materials, etc.

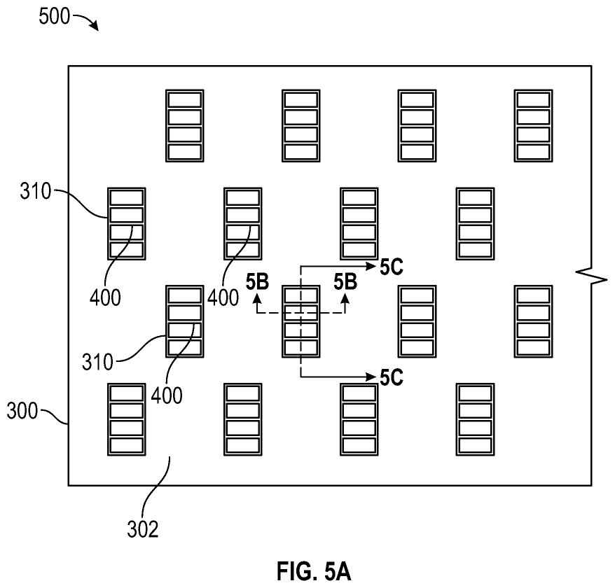

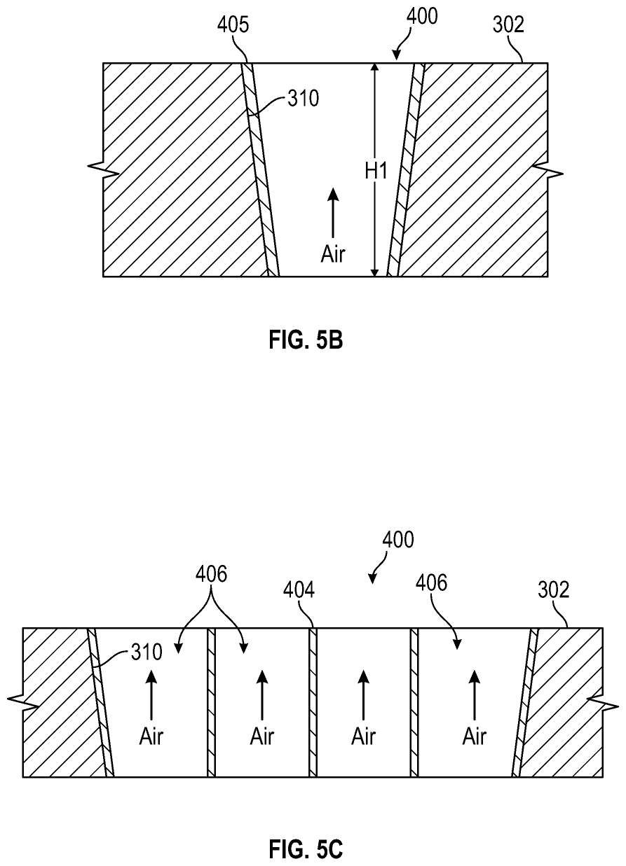

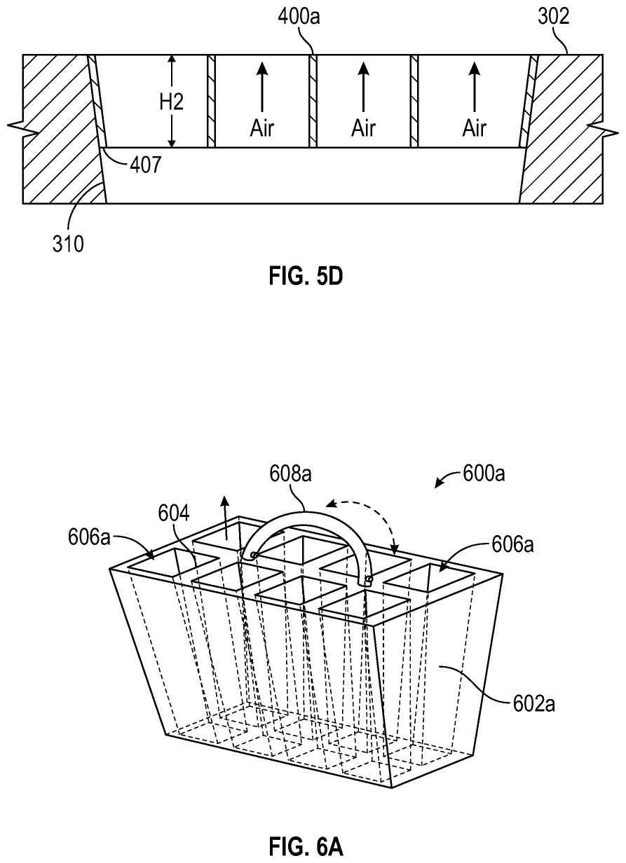

FIG. 5A is a top view of a vented floor assembly 500 configured in accordance with embodiments of the present technology, and FIGS. 5B and 5C are a cross-sectional side view and a cross-sectional end view, respectively, taken along lines 5C-5C and 5B-5B, respectively, in FIG. 5A. Referring first to FIG. 5A, in some embodiments the vented floor assembly 500 includes a plurality of the vent inserts 400 installed in corresponding vent openings 310 in the vented floor structure 300. Referring next to FIGS. 5B and 5C, as these Figures illustrate the insert 400 is configured to generally fit within the opening 310 so that, in some embodiments, the upper surface 405 of the insert 400 does not protrude above the top surface of the slab 302. Although the insert 400 of the illustrated embodiment is shown to have a height H1 that is the same, or at least approximately the same but less than, the thickness of the slab 302 (e.g., about 5 inches), in other embodiments vent inserts configured in accordance with the present technology can have different heights, including heights that are less than the thickness of the slab 302. For example, as shown in FIG. 5D, in some embodiments inserts 400a can have a height H2 that is substantially less than the overall thickness of the slab 302.

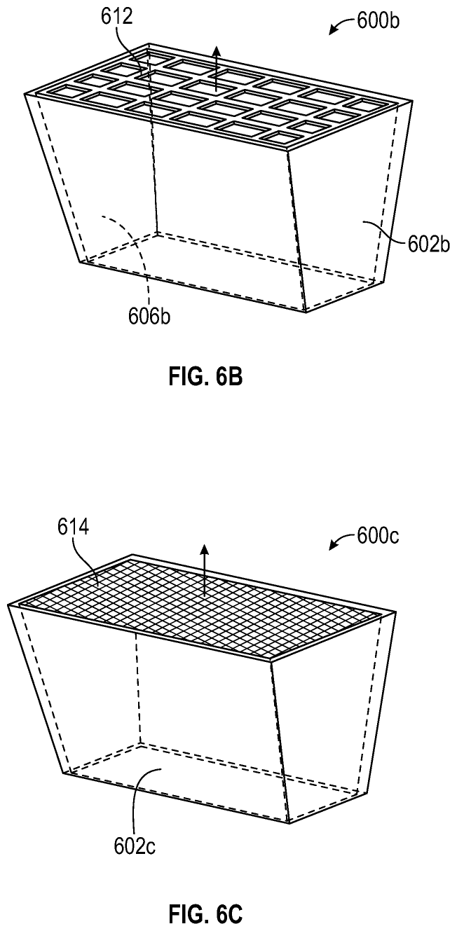

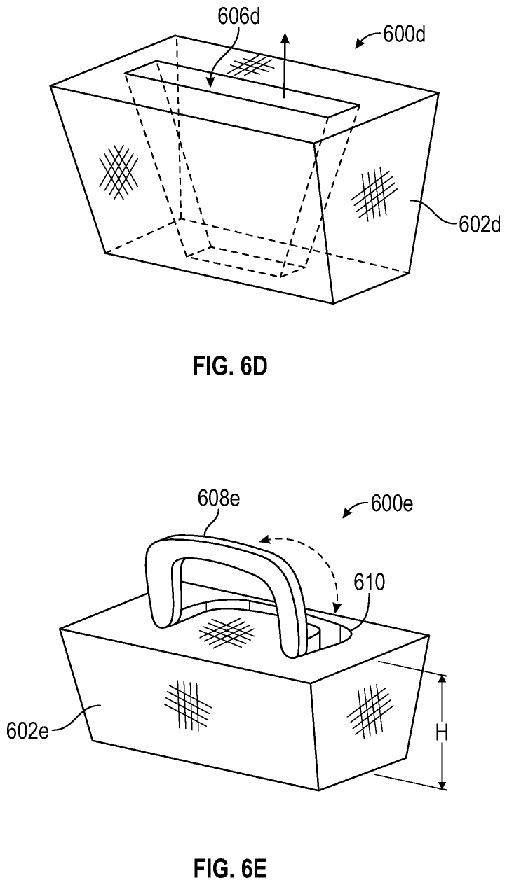

As noted above, vent inserts configured in accordance with the present disclosure can have a wide variety of different shapes, sizes and configurations depending on the particular use or desired function. For example, FIG. 6A-6E are top isometric views of vent inserts 600a-600e configured in accordance with some embodiments of the present technology. Each vent insert 600a-600e generally includes outer wall portions defining an interior passageway, and one or more structural features (e.g., inner walls, grates, screens, etc.) coupled to/extending between the outer wall portions. As described below, the one or more structural features can have various functions, including modifying the flow of air through the interior passageway, reducing clogging of the interior passageway, or the like. Referring first to FIG. 6A, in this embodiment the vent insert 600a includes a body 602a having a plurality of inner wall portions 604 that divide the vent insert 600a into a plurality of individual air passages 606a. In some embodiments, the inner wall portions 604 can extend longitudinally and/or transversely across the opening of the vent insert 600a, and can be the same height as the vent insert 600a or only extend for a portion of the height of the vent insert 600a. Additionally, in some embodiments the vent insert 600a includes a handle 608a to facilitate manual installation and removal of the vent insert 600a from a corresponding vent opening. In some embodiments, the handle 608a can be pivotally attached to the body 602a so that it can fold downwardly onto (or into a recess in) the upper surface of the vent insert 600a so that it does not protrude above the floor of the corresponding vented floor structure 300 and interfere with movement of personnel and/or equipment on the surface of the floor structure.

Turning next to FIG. 6B, in some embodiments the vent insert 600b includes a body 602b that is relatively open to create a single large air passage 606b. However, the vent insert 600b further includes a grate 612 that is positioned across the top of the passage 606b and suitably attached (via, e.g., screws, etc.) to the body 602a. In some embodiments, the grate 612 can be formed from a rigid grid, e.g., a steel grid, etc. and can provide relatively large openings in the grate (e.g., openings about 1 inch by 1 inch), yet the grate 612 can be sized to support the weight of personnel, storage bins, etc. that may be positioned on top of the grate 612. In some embodiments, the body 602b can be omitted, and vent inserts configured in accordance with the present technology can be comprised of just a grate or grate member that fits snugly into (or over) the upper portion of the corresponding vent opening and extends horizontally across the opening in a similar manner to the grate 612. Such vent inserts made include side edges or a “skirt” to facilitate locating the insert in the vent opening.

Turning next to FIG. 6C, in this embodiment the vent insert 600c has a body 602c that is at least generally similar in structure and function to the body 602b of the vent insert 600b, but in this embodiment the upper portion of the body 602c is covered by a mesh screen 614. In some embodiments, the screen 614 can be formed from a wire mesh (e.g., a stainless-steel mesh) of suitable gauge for, e.g., drying crops. For example, in some embodiments the mesh covered vent insert 600c can be used to dry hemp and/or other plant products stored thereon. In some embodiments, it is contemplated that the body 602c or a substantial portion thereof can be omitted so that the insert 600c is comprised mostly or completely of the screen 614. Additionally, in some embodiments the screen 614 can include reinforcement structure to support crops, personnel, equipment, and/or other loads that may be positioned on top of the vent insert 600c. It will be appreciated that, in some embodiments, the thickness of the sidewalls of the body 602c can be made thin enough that relatively little of the cross-sectional area of the vent opening (e.g., the vent opening 310) is taken up by the vent inset 600c.

In addition to the vent inserts 600a-c described above, in some embodiments vent inserts configured in accordance with the present disclosure can be used to vary the size of the vent opening in a vented floor structure. For example, as shown in FIG. 6D, the vent insert 600d includes a body 602d that is configured to be received in, and fill, a substantial portion of the corresponding vent opening (e.g., the vent opening 310; FIGS. 3A-3D) but also includes an air passage 606d that enables air to flow through the vent insert 600d. For example, in some embodiments the air passage 606d can have the same shape and size, or at least a substantially similar shape and size, as the vent openings 110 described in detail above with reference to FIGS. 1-2D. In other embodiments, vent inserts configured in accordance with the present disclosure can include other air passage configurations, shapes and sizes to tailor the particular volume and/or flow rate of air flowing through the vent insert for a particular application, crop, facility, treatment program, etc.

As described above with reference to FIG. 6A-6D, vent inserts configured in accordance with the present technology can be used to vary the size, shape, configuration and/or cover configuration of air vent passages through vented floor structures. In addition, vent inserts configured in accordance with the present technology can also be used to plug (e.g., entirely fill) one or more vent openings in a vented floor structure to prevent the flow of air through the selected vent openings. For example, as shown in FIG. 6E, the vent insert 600e includes a body 602e that is configured to fit within and plug the corresponding vent opening (e.g., the vent opening 310 described above with reference to FIGS. 3A-3D.) Although the body 602e is depicted as being solid or relatively solid for purposes of illustration, in other embodiments, vent inserts configured to plug vent openings can be formed from other structures configured to extend across and occlude the vent opening, such as a body having a top surface that extends across the opening but is relatively hollow, a flat plate, or virtually any configuration of body that can form a removable plug in the corresponding vent opening. For example, it should be noted that, in some embodiments the vent insert 600e can have a height H that is substantially less than the overall thickness of the corresponding slab of the vented floor structure (e.g., the slab 302 of the vented floor structure 300; FIG. 3C), but nevertheless the top surface of the insert 600e should be flush, or at least approximately flush, with the upper surface of the slab when installed to avoid creating a trip hazard or impeding movement of equipment or personnel on the vented floor assembly. Additionally, as illustrated in FIG. 6E, the vent insert 600e (as well as any of the other vent inserts described herein) can include a handle 608e to facilitate manual installation and removal of the vent insert 600e from the corresponding vent opening. In some embodiments, the handle 608e is configured to fold downwardly into a corresponding recess 610 formed in the body 602e. In this way, the handle 608e can be folded downwardly into the recess 610 so that it is flush with, or slightly below, the top surface of the vent insert so that the handle 608e does not impede or interfere with movement of personnel and/or equipment over the vent insert 600e in use.

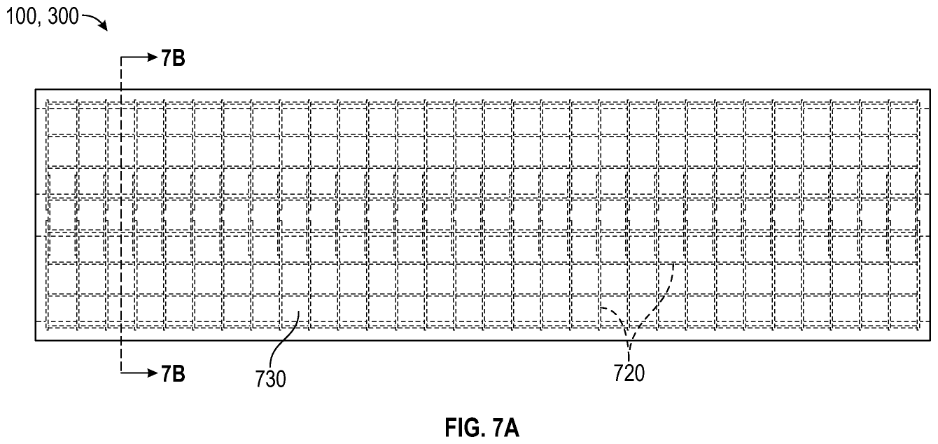

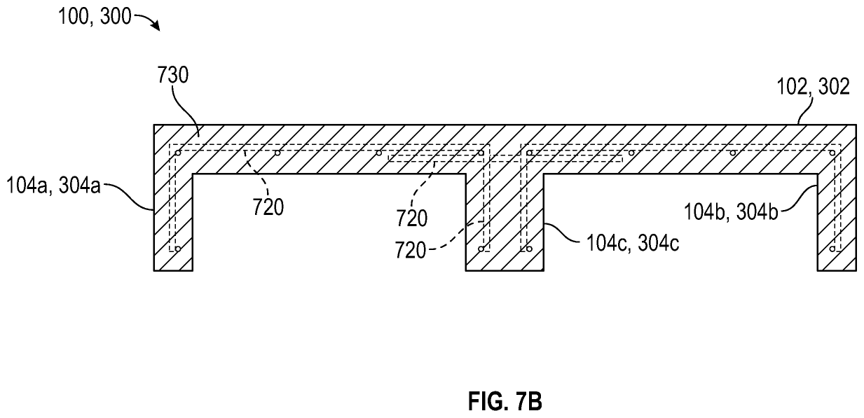

FIGS. 7A and 7B are top and cross-sectional end views, respectively, of the vented floor structures 100, 300 illustrating an arrangement of rebar 720 that can be cast into the structures to provide reinforcement in accordance with embodiments of the present technology. The vent openings 110, 310 are not shown in FIGS. 7A and 7B for ease of illustration. Referring to FIGS. 7A and 7B together, as described in greater detail below, in some embodiments, the vented floor structures 100, 300 can be formed by pouring concrete 730 (e.g., a mixture of Portland cement, water and aggregates (rock and sand)) into a form that contains a preinstalled arrangement of the rebar 720. Once the concrete 730 sets, the rebar 720 provides reinforcement to the precast concrete structure. As FIGS. 7A and 7B illustrate, the rebar 720 can be positioned in a lattice arrangement within the slabs 102, 302 and additional rebar members 720 can extend downwardly into the side walls 104a-c, 304a-c. It will be understood that the configuration of the rebar 720 illustrated in FIGS. 7A and 7B is provided by way of example only, as it is contemplated that a wide variety of different rebar sizes, arrangements, etc. can be included with the vented floor structures 100, 300 (or omitted) in accordance with the present technology.

FIG. 8A is a perspective end view of a form 800 that can be used to manufacture the vented floor structure 100 in accordance with embodiments of the present technology. In some embodiments, the form 800 includes opposing side walls 804a and 804b which extend upwardly from a base 802. A plurality of vent forms 810 are welded to the upper surface of the base 802 and extend upwardly therefrom. The vent forms 810 are sized and shaped to form the corresponding vent openings 110 in the slab 102 of the vented floor structure 100 (FIGS. 2A-2C), and accordingly, the vent forms 810 have the same, or substantially the same, shape and size as the corresponding vent openings 110. In particular, it will be noted that, as discussed above with reference to FIGS. 2C-2D, in some embodiments all four sides of the vent forms 810 taper inwardly in the direction away from the form base 802 (i.e., in the upward direction in FIG. 8A). It will also be noted that the form 800 is configured so that the vented floor structure 100 is cast in an inverted orientation in the form 800, such that the upper surface of the base 802 forms the top surface of the slab 102 and the opposing side walls 804a, b form the outer surfaces of the corresponding side walls 104a, b. The form 800 and parts thereof can be formed from suitable materials known in the art (e.g., metals, such as mild steel) using suitable methods known in the art (e.g., welding).

FIG. 8B is an end view illustrating use of the form 800 to manufacture the vented floor structure 100 in accordance with embodiments of the present technology. In this embodiment, two sub-forms 806a and 806b are installed on top of the vent forms 810 to form the bottom surface of the slab 102 and the inner surfaces of the side walls 104a-c of the vent floor structure 100. To cast the vented floor structure 100 with the forms 800 and 806a, b, rebar (not shown in FIG. 8B) can be arranged on the form 800 in, for example, the configuration described above with reference to FIGS. 7A and 7B using conventional methods known in the art. Next, the sub-forms 806a, b can be positioned on the vent forms 810 as shown in FIG. 8B, and the space between the respective forms can be filled with concrete 730. After the concrete sets, the sub-forms 806a, b can be removed from the cast floor structure 100 and the casting can in turn be removed from the main form 800. In one aspect of this embodiment, the inwardly angled (e.g., inwardly tapered) sides of the vent forms 810 make it easier to remove the cast concrete structure 100 from the main form 800 than if, for example, the front and back sides of the vent forms 810 were not tapered. By manufacturing vented floor structure castings in the foregoing manner, multiple such floor structure castings can be manufactured in bulk before being transported to a work site for installation in a crop storage building. Moreover, the vented floor structure castings can be manufactured absent any shell (e.g., plastic shell) positioned within the vent openings and/or around the vent forms 810. Although the form 800 is described above in the context of manufacturing the vented floor structure 100, use of a form that is substantially similar in structure and function to the form 800 can also be used to manufacture the vented floor structure 300 described above with references 3A-3D. For example, such a form would be substantially similar to the form 800, but with vent forms 810 that are appropriately sized, shaped and positioned to form the vent openings 310 instead of the vent openings 110.

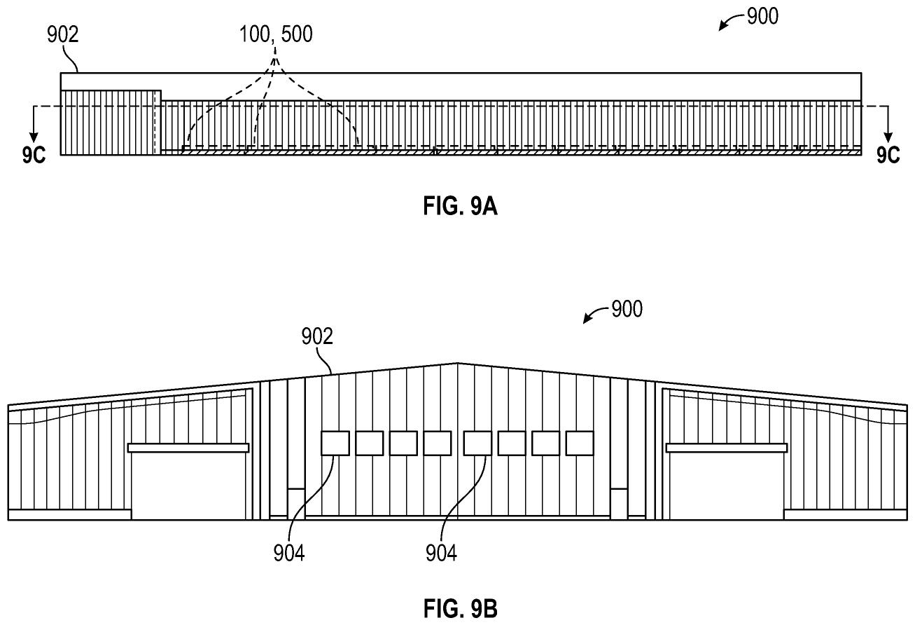

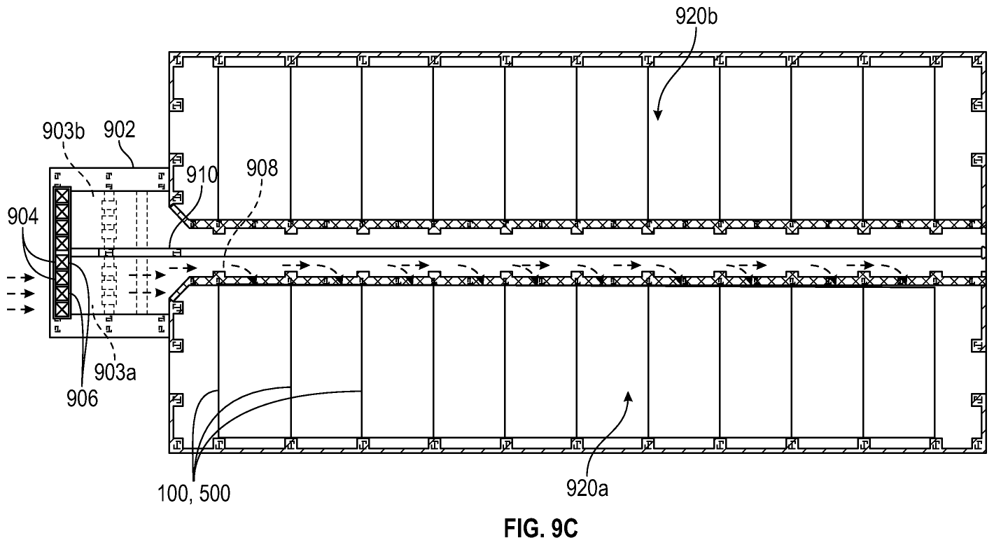

As noted above, the vented floor structures described herein can be used in a wide variety of storage facilities and with a wide variety of crops including, for example, potatoes, onions, carrots, apples, hemp, etc. By way of example, FIGS. 9A-9C are illustrative side, front end, and top cross-sectional views, respectively, of an example crop storage facility 900 that can include a plurality of the vented floor structures 100 and/or the vented floor assemblies 500 described above with respect to, e.g., FIGS. 1 and 5A, respectively. As those of ordinary skill in the art will recognize, the storage facility 900 can be used to store potatoes and other tubers, onions, carrots, etc., as well as a wide variety of other agricultural products, crops, produce, etc. Accordingly, although the storage facility 900 may be described herein in the context of a potato or onion storage facility, those of ordinary skill in the art will understand that the storage facility 900 and various structural and/or functional aspects of the vented floor structures described herein can also be used in a wide variety of other facilities to advantageously store a wide variety of crops, produce, etc. Accordingly, the technology disclosed herein is not limited to potato, onion, apples, carrots, hemp, and/or other particular types of storage facilities unless specifically indicated as such, and in general, it is contemplated that the vented floor structures described herein can be advantageously used with virtually any type of crop storage facility.

Turning first to FIGS. 9A and 9B, in some embodiments, the crop storage facility 900 can include a fan house 902 having a plurality of air inlets 904 on a forward end portion thereof. In some embodiments, the air inlets 904 are a series of generally rectangular openings that can be alternately opened or closed using suitable doors to introduce outside air into the facility 900 as desired. Although not illustrated in FIGS. 9A and 9B, in some embodiments, the crop storage facility 900 can include a mezzanine deck in the fan house 902, and the air inlets 904 can be positioned above the mezzanine deck.

FIG. 9C is a top cross-sectional view taken substantially along line 9C-9C in FIG. 9A and just above the mezzanine deck of the storage facility 900. As this view illustrates, the crop storage facility 900 includes a central partition wall 910 extending longitudinally along the center of the facility 900. In some embodiments, the storage facility 900 is generally symmetrical about the central partition wall 910, such that the central partition wall 910 divides the fan house into two adjacent fan rooms (identified individually as a first fan room 903a and a second fan room 903b), and the crop storage area into two separate crop storage bays (identified individually as a first storage bay 920a and a second storage bay 920b). For ease of reference and understanding, the following description describes the various structures and functions of the storage facility 900 from the perspective of the first fan room 903a and the first storage bay 920a, but it should be understood that, because of the symmetry of the illustrated embodiment, the description of these structures and functions applies equally well to the corresponding second fan room 903b and second storage bay 920b on the opposite side of the partition wall 910. It will also be understood that in other embodiments, other storage facilities having vented floor structures configured in accordance with the present technology can be asymmetrical, and/or they can have only a single crop storage bay or more than two crop storage bays. Accordingly, the technology disclosed herein is not limited to any particular storage facility configuration.

In operation, air flows into the fan house 902 via the air inlets 904, and then into the first fan room 903a via a plurality of recirculation vents in the mezzanine deck. The fan room 903a can include one or more air movers and/or an air cooler (e.g., an evaporative cooler) for cooling and/or humidifying the outside air and moving it from the fan room 903a and into a corresponding air plenum 908 that extends substantially along the length of the crop storage facility 900 at the ground floor level. In some embodiments, a plurality of the vented floor structures 100 and/or the vented floor assemblies 500 are positioned adjacent to each other in the crop storage bay 920a such that the inlets (e.g., the inlets 112a, b or 312a, b; FIGS. 1 and 3A, respectively) are adjacent to and open to the plenum 908. This enables the air flowing down the plenum 908 to enter the corresponding plenums 114a, b or 314a, b of each of the vented floor structures 100 and/or the vented floor assemblies 500, respectively, and then flow upwardly through the vent openings 110 and/or the vent inserts 400, 600a-d, respectively. After flowing through the vent openings 110 and/or the vent inserts 400, 600a-d, the air flows upwardly through the crops and/or crop bins stored on top of the vented floor structures 100 and/or the vented floor assemblies 500 (FIG. 1 and FIG. 5A, respectively).

The foregoing example is but one possible use of the vented floor structures and vented floor assemblies described herein. Accordingly, it will be appreciated that these floor structures and assemblies can be used in a wide variety of crop storage facilities in various other configurations.

References throughout the foregoing description to features, advantages, or similar language do not imply that all of the features and advantages that may be realized with the present technology should be or are in any single embodiment of the invention. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment. Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.

Any patents and applications and other references noted above, including any that may be listed in accompanying filing papers, are incorporated herein by reference in the entirety, except for any subject matter disclaimers or disavowals, and except to the extent that the incorporated material is inconsistent with the express disclosure herein, in which case the language in this disclosure controls. Aspects of the invention can be modified, if necessary, to employ the systems, functions, and concepts of the various references described above to provide yet further implementations of the invention.

The above Detailed Description of examples and embodiments of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. The teachings of the invention provided herein can be applied to other systems, not necessarily the system described above. The elements and acts of the various examples described above can be combined to provide further implementations of the invention. Further any specific numbers noted herein are only examples: alternative implementations may employ differing values or ranges.

While the above description describes various embodiments of the invention and the best mode contemplated, regardless how detailed the above text, the invention can be practiced in many ways. Details of the system may vary considerably in its specific implementation, while still being encompassed by the present disclosure. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/We claim:

1. A vented floor assembly for use in a crop storage area, the vented floor assembly comprising:
a vented floor structure having:
a first surface configured to support crops stored in the crop storage area,
a second surface opposite the first surface, and
a plurality of vent openings extending between the first surface and the second surface; and
one or more vent inserts removably positionable within the vent openings to define one or more passages therethrough.

2. The vented floor assembly of claim 1 wherein individual vent inserts of the one or more vent inserts include:
a plurality of outer wall portions, and
one or more inner wall portions extending between the plurality of outer wall portions, the one or more inner wall portions defining two or more air passageways through the vent insert.

3. The vented floor assembly of claim 1 wherein individual vents of the one or more vent inserts include a single air passageway through the vent insert.

4. The vented floor assembly of claim 3 wherein the individual vent inserts further comprise a grate or mesh screen positioned across a top of the single air passageway.

5. The vented floor assembly of claim 1 wherein individual vent inserts of the one or more vent inserts include a grate or mesh screen extending across an upper portion thereof.

6. The vented floor assembly of claim 1 wherein individual vent inserts of the one or more vent inserts block air flow through the corresponding vent opening.

7. The vented floor assembly of claim 1 wherein individual vent inserts of the one or more vent inserts include a gripping feature for removing the vent insert from the corresponding vent opening.

8. The vented floor assembly of claim 1, further comprising a slab having the first and second surfaces, wherein the one or more vent inserts have a height that is about equal to a thickness of the slab, the thickness being defined by a distance between the first surface and the second surface.

9. The vented floor assembly of claim 1, further comprising a slab having the first and second surfaces, wherein the one or more vent inserts have a height that is less than a thickness of the slab, the thickness being defined by a distance between the first surface and the second surface.

10. The vented floor assembly of claim 1 wherein the plurality of vent openings taper inwardly from the first surface toward the second surface.

11. The vented floor assembly of claim 1 wherein the plurality of vent openings have an isosceles trapezoid shape.

12. The vented floor assembly of claim 1 wherein the plurality of vent openings are formed absent shells surrounding the vent openings.

13. The vented floor assembly of claim 1 wherein the one or more vent inserts include at least a first vent insert having a first configuration and a second vent insert having a second configuration, different than the first configuration, and wherein the plurality of vent openings are compatible with both the first vent insert and the second vent insert such that flow through the vented floor assembly can be customized by installation of the first vent insert or the second vent insert in one or more of the vent openings.

14. The vented floor assembly of claim 1, further comprising one or more side walls extending downwardly from the second surface and configured to at least partially form one or more plenums.

15. A removable vent insert for use with a vented floor structure in a crop storage area, the removable vent insert comprising:
a plurality of outer wall portions defining an interior passageway therebetween; and
one or more structural features coupled to one or more of the outer wall portions, the one or more structural features configured to (a) modify the flow of air through the interior passageway and/or (b) reduce clogging of the interior passageway,
wherein the vent insert is configured to removably fit within a vent opening in the vented floor structure.

16. The removable vent insert of claim 15 wherein the one or more structural features include one or more inner wall portions extending between the plurality of outer wall portions, the one or more inner wall portions dividing the interior passageway into two or more air passageways extending through the vent insert.

17. The removable vent insert of claim 15 wherein the one or more structural features include a grate or mesh screen extending across the interior passageway.

18. The removeable vent insert of claim 15 wherein the one or more structural features include a plug configured to block air from flowing through the interior passageway.

19. The removeable vent insert of claim 15 wherein the vent insert has a tapered shape defined by the outer walls portions.

20. The removable vent insert of claim 15 wherein the vent insert has an isosceles trapezoid shape defined by the outer wall portions.

21. The removable vent insert of claim 15, further comprising a gripping feature for removing the vent insert from the vent opening in the vented floor structure.

22. A method for manufacturing a vented floor structure, comprising:
accessing a vented floor structure form having a base and a plurality of vent forms extending upwardly from the base, wherein the plurality of vent forms taper inwardly in a direction away from the base;
filling a space around the vent forms with pourable concrete; and
after the concrete sets into a cast structure, removing the cast structure from the vented floor structure form, the cast structure having a plurality of tapered vent openings corresponding to the plurality of vent forms.

23. The method of claim 22, further comprising positioning one or more sub-forms on top of the plurality of vent forms before filling the space with the pourable concrete, wherein the one or more sub-forms are configured to form (a) a bottom surface of the vented floor structure, and (b) inner surfaces of side walls of the vented floor structure.

24. The method of claim 22, further comprising positioning rebar along the vented floor structure form in the space around the vent forms before filling the space with the pourable concrete, wherein the rebar is included in the cast structure.

25. The method of claim 22 wherein the plurality of vent openings have an isosceles trapezoid shape.

26. The method of claim 22 wherein filling the space around the vent forms is performed absent placing any shell structure around the vent forms before filling the space.

27. The method of claim 22 wherein the plurality of tapered vent openings of the cast structure are formed absent any shell such that surfaces of the plurality of tapered vent openings are composed of the concrete.

28. The method of claim 22 wherein individual vent openings of the plurality of vent openings are configured to receive a vent insert for controlling the flow of air therethrough.

29. A precast vented floor structure for use in a crop storage area, the precast vented floor structure comprising:
a slab having a first surface configured to support crops stored in the crop storage area and a second surface opposite the first surface; and
a plurality of vent openings extending between the first and second surface, wherein individual vent openings of the plurality of vent openings have sidewalls formed directly by the slab and in the absence of a cast-in shell.

30. The precast vented floor structure of claim 29, further comprising one or more side walls extending downwardly from the second surface and configured to at least partially form one or more plenums.

31. The precast vented floor structure of claim 29 wherein individual vent openings of the plurality of vent openings taper inwardly from the first surface toward the second surface.

32. The precast vented floor structure of claim 29 wherein individual vent openings of the plurality of vent openings have an isosceles trapezoid shape.

33. The precast vented floor structure of claim 29 wherein individual vent openings of the plurality of vent openings have sidewalls formed directly by the slab and in the absence of any cast-in structures.
